(19) United States
(12) Patent Application Publication
(10) Pub. No.: US 2011/0117238 A1
(43) Pub. Date: May 19, 2011

(54) INJECTION MOLDING NOZZLE FOR AN INJECTION MOLDING TOOL

(75) Inventors: Herbert Gunther, Allendorf (DE); Siegrid Sommer, Burgwald (DE)

(73) Assignee: GUNTHER HEISSKANALTECHNIK GMBH, Frankenberg (DE)

(21) Appl. No.: 12/997,294

(22) PCT Filed: May 7, 2009
(86) PCT No.: PCT/EP2009/003261

§ 371 Date: Feb. 1, 2011

(30) Foreign Application Priority Data
Jun. 16, 2008 (DE) 20 2008 007 918.7

(51) Int. Cl. B29C 45/20

(52) U.S. Cl. 425/569

(57) ABSTRACT

The invention relates to an injection mold's injection nozzle (10) comprising a feed pipe (12) subtending in the axial direction (A) a flow duct (16) for a flowable/fluid material, a nozzle tip (26) being inserted into the feed pipe (12) and extending the flow duct (16). In order to reduce temperature drops, the injection molding nozzle (10) encloses at least one thermal insulator (32) resting against the injection mold and at least partly enclosing the nozzle tip (26).

The present invention relates to an injection mold nozzle defined in the preamble of claim 1.

Injection nozzles are used in injection molds to feed a flowable/fluid material such as a melt of plastic at high pressure to a separable mold block respectively a mold insert of an injection mold.

Optimal operational results require to keep said flowable material at a predetermined temperature as far as its access into the mold cavity. Typically a heater heats the feed pipe to an appropriate temperature. Equally importantly, however, the fluid material shall solidify shortly after entering the mold insert of the injection mold, and therefore the mold insert is cooled. These two requirements conflict with each other especially in the transition zone from the nozzle tip to the mold insert, the nozzle tip demanding a high, predetermined temperature and the mold insert demanding a predetermined low one.

In the prior art, the U.S. Pat. No. 5,028,227 for instance proposes an injection molding nozzle fitted at the lower end of the feed pipe with a nozzle insert which is made of a highly thermally conducting substance and which rests against the injection mold's insert. An elongated torpedo-like flow body—hereafter streamlined body—is configured within the feed pipe and enclosed by the nozzle insert, and also is made of highly thermally conducting substance. This streamlined body is fitted with a flange-like, outwardly pointing ring to fix it in place between the feed pipe and the nozzle inserts, further with ribs that run longitudinally and subtending channels within said feed pipe to move the flowable material. This streamlined body is designed/intended to compensate the drop in temperature entailed by the heat exchange taking place at the mutually touching contact surfaces of the nozzle insert and the mold insert, namely by guiding heat from the feed pipe by means of the streamlined body directly into the gate zone.

A similar design is disclosed in the German patent document DE 31 24 909 A. Therein, an injection molding nozzle is fitted with a thermally highly conductive nozzle seal configured between the feed pipe and the mold insert of the injection mold. The nozzle seal comprises a cylindrical outer part of which the circumferential outer surface is slightly conical. Also the outer edge is slightly bevelled to reduce contact with the mold insert. On its inside, the outer part subtends three ribs running radially to a longitudinal central pin. Apertures passing the melt are configured between the ribs. Said central pin is conical at its end, its tip projecting as far as the gate.

An alternative design of an injection molding nozzle further is disclosed in the U.S. Pat. No. 4,450,999, differing from that of the above German patent document DE 31 24 909 A in that the nozzle seal's central pin is separate from the outer part of the nozzle seal.

In the light of the above state of the art, the objective of the present invention is to create a new injection molding nozzle design allowing further optimization of production.

Claim 1 defines the independent features of the present invention and claims 2 through 25 define illustrative embodiments of said invention.

At least one thermal insulator is used for an injection nozzle of an injection mold comprising a feed pipe subtending an axial flow duct for a flowable/fluid material, said nozzle being fitted with a tip which is inserted into the feed pipe and which, in the design of the invention, extends the flow duct, said thermal insulator at least partly enclosing the nozzle tip and, in the design of the invention, resting against the injection mold.

Contrary to the above cited state of the art which aims to compensate the heat transfer between the nozzle tip and the injection mold insert by configuring a streamlined body, the present invention suppresses as much as feasible the heat loss by using an appropriate insulator. In this manner at least constant quality operational output articles may be attained.

Furthermore, inserting the nozzle tip into the feed pipe allows rapidly changing the nozzle tip during maintenance and/or replacement work, the nozzle tip exchange requiring no accessories such as tools or the like.

Again, because the nozzle rests in the direction of the mold against said insulator, a nozzle tip stop need not be provided within the feed pipe, and accordingly the pressure drop is commensurately less. Optimal melt flow through the melt duct in the nozzle tip is implemented.

The design of the invention is simple overall, allowing easy installation and disassembly, advantageous pressurization being implemented by configuring the nozzle tip in the feed pipe.

Preferably the minimum of one insulator makes contact, in a plane transverse to the axial direction, with the injection mold, as a result of which the insulator and hence also simultaneously the nozzle tip resting on the insulator shall be positioned axially within said injection mold. Also the insulator is designed in a way to center the nozzle tip and hence the injection molding nozzle within said mold.

Preferably the minimum of one insulator is detachably affixed to the nozzle tip. The insulator and the nozzle tip can be preassembled and in that state be inserted into the injection mold. This feature facilitates installing and disassembling both parts. The affixation of the insulator to the nozzle tip may be frictional or force-fitted and/or in geometrically interlocking manner. In one embodiment mode of the present invention, the insulator is appropriately affixable by at last one fastener to the nozzle tip.

In order it be able to define the nozzle tip's depth of insertion into the feed pipe, said tip preferably shall be fitted with a flange rim, the nozzle tip by means of the flange rim's end face resting against the feed pipe. Preferably the insulator is affixable to the outer circumference of the flange rim. For that purpose the flange rim advantageously subtends at its outer circumference a recess that might be in the form of a circumferential groove. In that case a fastener such as a screw or a threaded bolt or the like may engage said recess, as a result of which the insulator may be affixed rapidly and reliably to the nozzle tip. Because of its compactness, advantageously this screw is a set screw. In addition or alternatively, the insulator also may be force-fitted onto the flange rim or be fastened to it in some other way.

Advantageously the insulator shall be annular in order to enclose a large area of the nozzle tip and screen it thermally commensurately.

The substances used for the feed pipe and the nozzle tip are selected advantageously in relation to their thermal coefficients of expansion in a manner that at operational temperature, the contact surfaces of the feed pipe and of the nozzle tip shall constitute a seal. As a result, the plastic melt to be processed is prevented from leaking to the outside.

Moreover the feed pipe, nozzle tip and insulator are designed to be assembled to each other with a little play at room temperature. Accordingly these parts are matched regarding the displacement plays, allowing both simple and rapid assembly and disassembly.

Also, at least one separate seal is preferably used between the feed pipe and the nozzle tip, for instance being in the form of a washer, as a result of which leaking of the flowable material between said pipe and tip is also precluded.

In a preferred embodiment mode of the present invention, the nozzle tip is centrally fitted at its transmission aperture with a streamlined body which is held in place by webs at a tubular case of the nozzle tip. Similarly to the state of the art, said streamlined body guides heat from the feed pipe directly to into the gate zone. For that purpose, the streamlined body at its end preferably projects beyond the nozzle tip's case in order that it may as near as possible to the gate or—if needed—even enter it.

The webs centering the streamlined body within the nozzle tip sub-divide said tip's cross-sectional aperture preferably into equal channels so that the flowable material flows homogeneously through the tip. As a result the melt's flow behavior is optimal. The pressure drop within the nozzle is minute.

In another significant embodiment of the invention, the webs are configured in the upper zone of the nozzle tip in a way that the flow-enhancing body freely passes through the lower nozzle tip zone. This feature further improves the melt flow efficacy; the feed material arrives in its most optimal state into the mold cavity, thereby nearly entirely eliminating the so-called memory effect. Also colors may be changed extremely quickly, with a commensurate saving in production costs.

Again the nozzle tip advantageously also comprises a further thermal insulator which preferably is configured between the feed pipe the injection mold in order to extremely effectively suppress heat transfer between said feed pipe and injection mold. The second insulator preferably is designed to center the injection nozzle within the injection mold.

Further features, particulars and advantages of the present invention are defined in the claims and in the following description of illustrative embodiments in relation to the appended drawings.

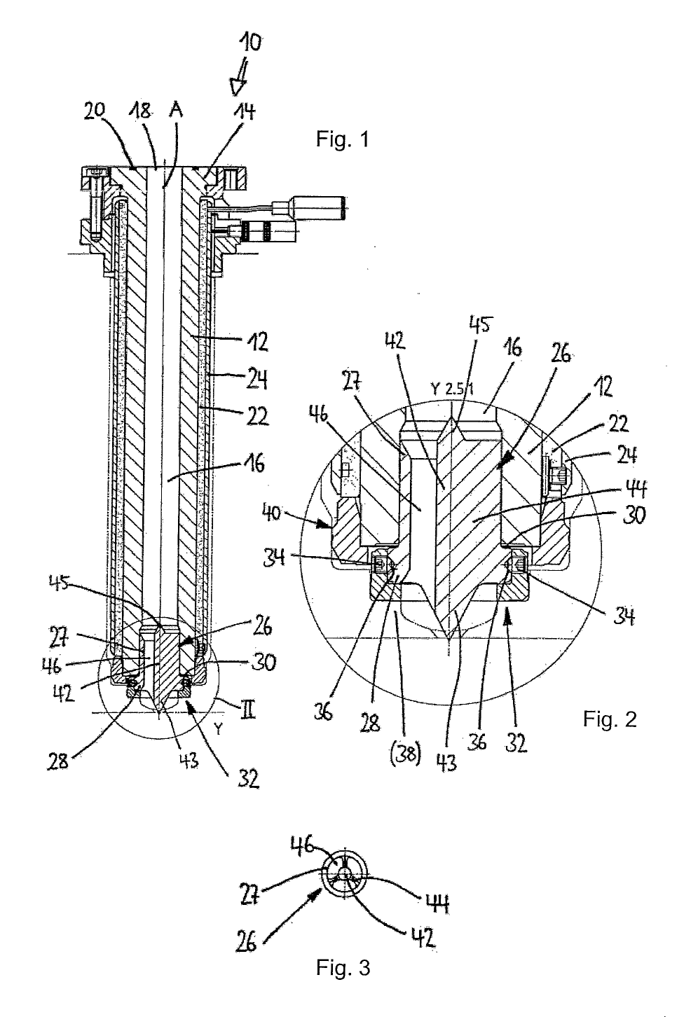

FIG. 1 is a cross-sectional view of the injection molding nozzle of one embodiment mode of the present invention,

FIG. 2 is an enlarged detail II of FIG. 1,

FIG. 3 is a bottom view of the nozzle tip of the nozzle shown in FIG. 1, and

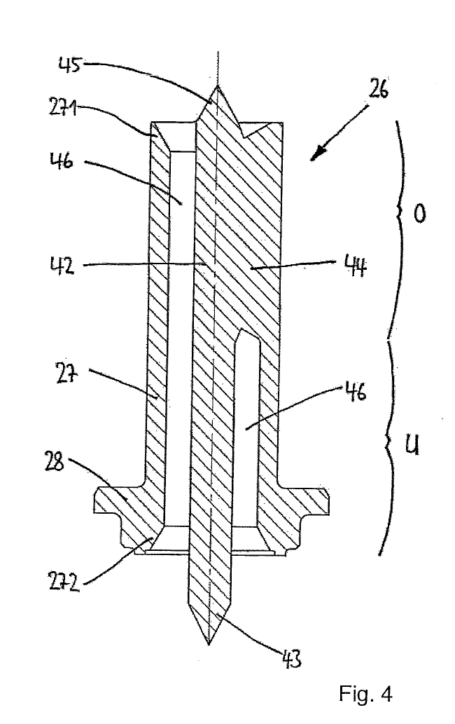

FIG. 4 is an enlarged cross-sectional view of the nozzle tip.

The cross-sectional elevation of FIG. 1 shows an injection molding nozzle 10 of one embodiment mode of the present invention. This injection molding nozzle 10 is used in an omitted injection mold for making molded parts from a flowable/fluid material such as a melt of plastic. Typically such an injection is mold comprises a clamping plate and parallel thereto a manifold plate subtending within it a system of flow channels. Said channels issue into several injection molding nozzles 10 mounted to the manifold plate's underside. However single nozzles also may be used, in which case the machine nozzle of the injection mold onto the injection nozzle 10.

In the embodiment mode of FIG. 1, the injection molding nozzle 10 comprises a feed pipe 12 which is fitted at its upper end with a flange-like connection head 14 by means of which the feed pipe 12 can be connected to the omitted manifold plate of said injection mold. A flow duct 16 for the flowable material is configured centrally within the feed pipe 12 that runs in the axial direction A. The flow duct 16 preferably is a borehole and is fitted in the connection head 14 with a feed input aperture 18 communicating with the manifold plate's flow ducts or—alternatively directly—with the machine nozzle. An O-ring or the like 20 is fitted concentrically with the feed input aperture 18 in the connection head 14 to seal the feed pipe 12 against the manifold plate, said seal however being omitted when a single nozzle is used. Conceivably as well, an additional annular centering element may be used to facilitate mounting the feed pipe 12 to the injection mold.

A heater 22, for instance a thick film heater, a conventional coiled heater or a cable heater, is mounted on the outside of the feed pipe 12. The heater 22 heats the feed pipe and hence the melt passing through the said feed pipe. The feed pipe 12 is made of a thermally highly conducting substance, for instance tool steel, to optimize heat transfer to said melt. The heater 22 as a whole is enclosed by a sheath tube 24 protecting it against damage and preferably being thermally insulating relative to the outside.

As FIG. 2 shows in further detail, a nozzle tip 26 is inserted into the lower end of the feed pipe 12. The nozzle tip 26 is made of a thermally highly conducting substance, the substances of the feed pipe 12 and of the nozzle tip 26 being selected on the basis of their thermal coefficients of expansion in a manner that when the operational temperature has been reached, said pipe and tip shall constitute a seal, as a result of which the nozzle tip 26, when reaching said operational temperature, shall be firmly held in said pipe in fluid-tight manner. The material pipe 12 and the nozzle tip 26 moreover are designed so that, when at room temperature, they can be assembled with little play, whereby the said nozzle tip not only may be quickly installed, but also be easily disassembled, as soon as the injection mold has cooled to room temperature.

The nozzle tip 26 comprises a tubular casing 27 which is terminally fitted with a radially projecting flange rim 28. The end face of said flange rim 28 pointing to the feed pipe 12 constitutes a rest surface defining the depth of insertion of the nozzle tip 26 into the feed pipe 12. A supplementary sealing washer 30 or the like is configured between the flange rim 28 and the feed pipe 12 additionally sealing the two parts 12, 26 from each other.

As further shown by FIG. 2, a first insulator 32 made of a thermally poorly conducting substance such as titanium is configured between the nozzle tip 26 and the cold mold (not further discussed herein) to thermally insulate them from each other. It is designed as an annular sleeve slipped onto the flange rim 28 and enclosing much of nozzle tip 26 projecting from the feed pipe 12. FIG. 2 furthermore shows that the sleeve 32 encloses the peripheral zone of the flange rim 28 as well as the end face of this rim pointing away from the feed pipe 12, as a result of which the nozzle tip 26 cannot make direct contact with the mold.

The insulator 32 is detachably affixed by set screws 34 to the nozzle tip 26, said set screws passing through matching threaded holes and engaging the flange 28. These threaded holes are fitted radially into the wall of the insulator 32. FIG. 2 shows two mutually opposite screws 34. However only one, or more screws 34 may be used, for instance four. To further improve the affixation in the axial direction A of the insulator 32, a recess 36 in the form of a circumferential groove at the level of the screws 34 is fitted into the flange rim 28 of the nozzle tip 26. Accordingly said screws are able to engage the groove 36 and in this manner they can secure the insulating sleeve 32 to the nozzle tip 26.

The end face of the insulator 32 pointing away from the feed pipe 12 rests against an offset 38 of the injection mold not shown in further detail and circumferentially makes direct contact with this offset, as a result of which the insulator 32 is centered in the injection mold's offset 38. The nozzle tip 26 and hence the entire injection nozzle 10 is centered the same way in said injection mold. FIG. 2 shows clearly that the insulator 32 prevents direct contact between the nozzle tip 26 the said injection mold, and accordingly both parts are thermally insulated from each other.

An additional insulator 40 is configured at the lower end to the outer circumference of the feed pipe 12. This additional insulator 40 also is made of a thermally poorly conducting substance and is used to insulate the feed pipe 12 from the injection mold. Centering the feed pipe 12 within said apparatus also may be implemented by means of said insulator 40.

Heat transfer between the injection nozzle 10 and the injection mold is largely prevented using the insulators 32 and 40. Accordingly, the nozzle tip 26—merely inserted into the feed pipe 12—may be exchanged together with the pre-assembled insulating sleeve resp. the insulating annulus 32 when necessary. However the insulating annulus 32 may also be dismantled from the nozzle tip 26 rapidly and conveniently by loosening the screws 34, for instance when only said tip need be exchanged.

To further compensate the residue of not fully avoidable temperature drops in the vicinity of the nozzle tip 26, an elongated and substantially torpedo-like streamlined body 42 is configured centrally to the casing 27 of the nozzle tip 26 and is centrally kept in place by means of webs 44 in the tubular casing 27. This streamlined body guides heat directly from the feed pipe 12 into the zone of the gate. The streamlined body projects on both sides of the casing 27 by terminal nibs 43, 45, the lower terminal nib 43 almost reaching the gate or even entering it. The webs 44 keeping the streamlined body 42 in place in the nozzle tip 26 resp. its casing 27, do define channels 46 passing the flow of fluid material.

FIG. 4 shows a further advantageous embodiment of the invention, in particular of the nozzle tip 26. In this design the webs 44 within the said tip 26 resp. in the casing 27 are shortened in a way that they are restricted to the upper region O of said tip. On the other hand, in the lower region of U of said tip 26, the streamlined body 42 extends in contactless manner freely through the casing 27, allowing the melt to flow almost optimally in this lower region. In particular the orientation of the melt in the product-item is very largely eliminated, as a result of which the so-called memory effect is suppressed. It is clear from FIG. 4 that the lower terminal nib 43 is substantially longer than the upper terminal nib 45, the lower nib 43 projecting relatively far beyond the flange rim 28.

The upper edge 271 and the lower edge 272 of the casing 27 is conical or funnel-like to further improve the flow behavior, as a result of which the melt of plastic experiences minimal drop in pressure moving from the flow duct 16 in the feed pipe 12 into the transmission channels 46 of the nozzle tip 26.

The design of the injection molding nozzle 10 shown in FIGS. 1 through 4 offers the advantage in that the insulators 32 and 40 very effectively suppress any heat transfer between the injection nozzle 10 and the injection mold. At the same time additional heat is guided from the feed pipe 12 by means of the streamlined body 42 into the gate zone, whereby temperature drops that cannot be precluded by the insulator 32 in the gate zone can be compensated. Accordingly the injection molding nozzle 10 of the present invention makes possible excellent products.

The nozzle tip 26 being merely inserted into the feed pipe 12 of the injection nozzle 10, it can be installed and disassembled in simple manner. Compared to a nozzle tip which is screwed into a feed pipe, this feature of the invention allows a definite reduction of the pressure drop.

The insulator 32 being affixed to the nozzle tip 26, said insulator and nozzle tip may be preassembled, simplifying installing the injection nozzle 10 in said injection mold. Be it borne in mind in this respect that the mode of affixing the insulator 32 to the nozzle tip 26 may also be modified. Illustratively the insulator 32 also may be force-fitted onto the outer circumference of the flange rim 28 of the nozzle tip 26.

All features and advantages, inclusive design details, spatial configurations and procedural steps explicitly stated in or implicit in the claims, specification and drawings, may be construed being inventive per se or in arbitrary combinations.

### LIST OF REFERENCES

10 injection molding nozzle 34 set screw
12 feed pipe 36 recess/groove
14 connection head 38 offset
16 flow duct 40 insulator
18 input aperture 42 streamlined body
20 connection seal 43 terminal nib
22 heater 44 web
24 tubular sheath 45 terminal nib
26 nozzle tip 46 channel
27 casing
28 flange rim A axial direction
30 sealing washer O upper region
32 insulator U lower region

1. An injection molding nozzle (10) for an injection mold, comprising a feed pipe (12) subtending a flow duct (16), for a flowable/fluid material, running in the axial direction (A), further comprising a nozzle tip (26) inserted into said feed pipe (12) and extending the flow duct (16) in the design of the invention, further at least one thermal insulator (32) at least partly enclosing the nozzle tip (26) and, in its specified design state, resting against the injection mold.

2. Injection molding nozzle as claimed in claim 1, characterized in that the insulator (32) makes contact with the injection mold in a plane transverse to the axial direction (A).

3. Injection molding nozzle as claimed in claim 1, characterized in that the insulator (32) is designed to center the nozzle tip (26) within the injection mold.

4. Injection molding nozzle as claimed in claim 3, characterized in that the insulator (32) is detachably affixable to the nozzle tip (26).

5. Injection molding nozzle as claimed in claim 3, characterized in that the insulator (32) is affixable frictionally and/or in geometrically interlocking manner to the nozzle tip (26).

6. Injection molding nozzle as claimed in claim 3, characterized in that the insulator (32) is affixable by at least one fastener (34) to the nozzle tip (26).

7. Injection molding nozzle as claimed in claim 3, characterized in that the nozzle tip (26) is circumferentially fitted with a flange rim (28).

8. Injection molding nozzle as claimed in claim 7, characterized in that the nozzle tip (26) rests by the end face of the flange rim (28) on the feed pipe (12).

9. Injection molding nozzle as claimed in claim 7, characterized in that the insulator (32) is affixable to the flange rim (28).

10. Injection molding nozzle as claimed in claim 9, characterized in that the flange rim (28) is fitted at its outer circumference with a recess (36).

11. Injection molding nozzle as claimed in claim 10, characterized in that the recess (36) is circumferential.

12. Injection molding nozzle as claimed in claim 6, characterized in that the fastener (34) is a screw entering the recess (36).

13. Injection molding nozzle as claimed in claim 7, characterized in that the insulator (32) is force-fitted onto the flange rim (28).

14. Injection molding nozzle as claimed in claim 1, characterized in that the insulator (32) is annular.

15. Injection molding nozzle as claimed in claim 1, characterized in that the thermal coefficients of expansion of the substances of the feed pipe (12) and of the nozzle tip (26) are selected in a manner that, when the operational temperature has been reached, the contact surfaces of the feed pipe (12) and of the nozzle tip (26) shall constitute a sealing washer.

16. Injection molding nozzle as claimed in claim 1, characterized in that the feed pipe (12), the nozzle tip (26) and the insulator (32) are designed in a way that at room temperature they are mounted into one another with slight play of displacement.

17. Injection molding nozzle as claimed in claim 1, characterized in that at least one separate sealing washer (30) is present between the feed pipe (12) and the nozzle tip (26).

18. Injection molding nozzle as claimed in claim 1, characterized in that the nozzle tip (26) is fitted with a streamlined body (42) configured centrally in its is transmission aperture.

19. Injection molding as claimed in claim 18, characterized in that the streamlined body (42) is fixed in place by means of webs (44) at a tubular casing (27).

20. Injection molding nozzle as claimed in claim 19, characterized in that the streamlined body (42) terminally projects beyond the casing (27).

21. Injection molding nozzle as claimed in claim 18, characterized in that the webs (44) sub-divide the transmission aperture of the nozzle tip (26) into channels (46).

22. Injection molding nozzle as claimed in claim 18, characterized in that the webs (44) are configured in such a manner in the upper region (0) of the nozzle tip (26) that the streamlined body (42) freely passes through the casing (27) in the lower region (U) of the nozzle tip (26).

23. Injection molding nozzle as claimed in claim 1, characterized in that a further thermal insulator (40) is provided.

24. Injection molding nozzle as claimed in claim 23, characterized in that the further insulator (40) is configured between the feed pipe (12) and the injection mold.

25. Injection molding nozzle as claimed in claim 23, characterized in that the further insulator (40) centers the injection molding nozzle (10) within the injection mold
